(19) United States
(12) Patent Application Publication
(10) Pub. No.: US 2010/0307537 A1
(43) Pub. Date: Dec. 9, 2010

(54) METHOD AND APPARATUS IN PNEUMATIC MATERIAL CONVEYING SYSTEM

(76) Inventor: Göran Sundholm, Tuusula (FI)

Correspondence Address: BIRCH STEWART KOLASCH & BIRCH, PO BOX 747, FALLS CHURCH, VA, 22040-0747, US

(21) Appl. No.: 12/809,124

(22) PCT Filed: Dec. 18, 2008
(86) PCT No.: PCT/FI2008/050761

§ 371 Date: Jun. 18, 2010

(30) Foreign Application Priority Data
Dec. 21, 2007 (FI) 20075950
Dec. 21, 2007 (FI) 20075951
Feb. 18, 2008 (FI) 20085145

(51) Int. Cl. B08B 5/04; A47L 9/00

(52) U.S. Cl. 134/21; 15/300.1

(57) ABSTRACT

A method in a pneumatic material conveying system, such as a waste conveying system, which conveying system comprises at least one feed point (61) of material, particularly of waste material, a material conveying pipe (100) which is connectable to the feed point (61), a separator device (20) in which the material being conveyed is separated from conveying air, and means (3, 4) for providing a pressure difference in the conveying pipe (100) at least during the conveyance of the material. At least a part of the conveying piping (100) is connectable as a section of a circuit in which conveying air is circulated at least during the conveyance of the material with at least one first pump device, such as a vacuum unit (3), and with at least one second pump device, such as a blower unit (4).

### BACKGROUND OF INVENTION

The invention relates to a method according to the preamble of claim 1. The invention also relates to an apparatus according to claim 15.

The invention relates generally to pneumatic conveying systems, such as vacuum conveying systems, particularly to collecting and conveying waste, such as conveying household waste. More specifically, the invention relates to cleaning the conveying pipes of the material conveying systems in question.

Systems are known in which waste is conveyed in a piping by means of suction. In these, waste is conveyed for long distances in the piping by suction. Apparatuses are utilised, inter alia, for conveying waste in different institutions. Typical for them is that a vacuum apparatus is used for achieving a pressure difference, in which apparatus underpressure in the conveying pipe is provided with vacuum generators, such as vacuum pumps or an ejector apparatus. In the conveying pipe, there is typically at least one valve element by opening and closing of which make-up air coming in the conveying pipe is regulated. The vacuum conveying systems typically contain, inter alia, the following problems: high energy consumption, high air flow in the piping, problems with noise, dust and fine particles in the outlet pipe. Furthermore, prior-art apparatuses can have moisture problems. In rainy weather, the prior-art apparatuses can suck even e.g. 1,000 litres of water per suction from outdoor air. This causes problems with corrosion and blockages. For example, waste paper etc. sticks to the piping when moist. Furthermore, large systems have required arranging several separate make-up air valves, which increases the complexity and costs of the systems. Furthermore, the cleaning of the conveying piping is important, whereby the cleaning of a conveying system typically consisting of several separate branch pipes is awkward. Known arrangements do not enable the fast and cost-effective cleaning of the conveying piping.

An object of this invention is to achieve a totally novel arrangement into connection with material conveying systems by means of which the disadvantages of known arrangements are avoided. Another object of the invention is to provide an arrangement applicable for the cleaning of conveying pipes of vacuum conveying systems by means of which the cleaning process can be intensified. A further object is to provide a cleaning arrangement by means of which emissions of dust and fine particles and possible odour nuisances can simultaneously be decreased. An additional object is to decrease the production of moisture in the piping.

### BRIEF DESCRIPTION OF INVENTION

The method according to the invention is mainly characterised in that, in the method, at least a part of the conveying piping is connected as a section of a circuit in which conveying air is circulated at least during the conveyance of cleaning means and/or cleaning agent and/or liquid with at least one first pump device, such as a vacuum unit, and/or with at least one second pump device, such as a blower unit.

In addition, the method according to the invention is characterised by what is stated in claims 2-14.

The apparatus according to the invention is mainly characterised in that at least a part of the conveying pipe intended to be cleaned is connectable as a section of a circuit in which conveying air is circulated at least during the conveyance of cleaning means and/or cleaning agent and/or liquid with at least one first pump device, such as a vacuum unit, and/or with at least one second pump device, such as a blower unit.

Furthermore, the material conveying system according to the invention is characterised by what is stated in claims 16-25.

The arrangement according to the invention has numerous significant advantages. By arranging the conveying piping of the system to comprise a circuit where at least part of conveying air circulates, the volume of outlet air can be decreased. At the same time, the cleaning process can be performed quickly and effectively. By arranging a feed point and a return point of the cleaning means close to each other, the cleaning process can be performed easily and effectively. The cleaning process can be easily automatised and the same cleaning means can be re-used and circulated in the system. At the same time, the energy consumption of the system is minimised. By maintaining underpressure and simultaneously blowing, it is possible to provide an effective circulation of conveying air in the circuit and conveyance of cleaning means and/or cleaning agent and/or liquid in the conveying pipe. By arranging the conveying pipe of the material conveying system to consist of operating areas i.e. partial circuits, it is possible to effectively arrange the cleaning of different parts of the piping. With the arrangement according to the invention, it is also possible to decrease the volume of outlet air substantially and simultaneously to decrease possible problems with dust and fine particles in the outlet pipe. The arrangement according to the invention also substantially decreases the noise problem caused by prior art. After cleaning, the conveying piping can be dried by circulating air in the piping. As the volume of air being sucked inside decreases, also energy consumption decreases.

### BRIEF DESCRIPTION OF FIGURES

In the following, the invention will be described in detail by means of an example with reference to the accompanying drawings in which

FIG. 1 schematically shows a material conveying system,

FIG. 2 schematically shows another material conveying system,

FIG. 3 schematically shows a part of an apparatus according to the invention in connection with a material conveying system,

FIG. 4 schematically shows a system according to an embodiment of the invention in a second operating mode,

FIG. 5 schematically shows a part of a system according to a third embodiment of the invention in a third operating mode,

FIG. 6 schematically shows a part of the system according to the third embodiment of the invention in a fourth operating mode.

### DETAILED DESCRIPTION OF INVENTION

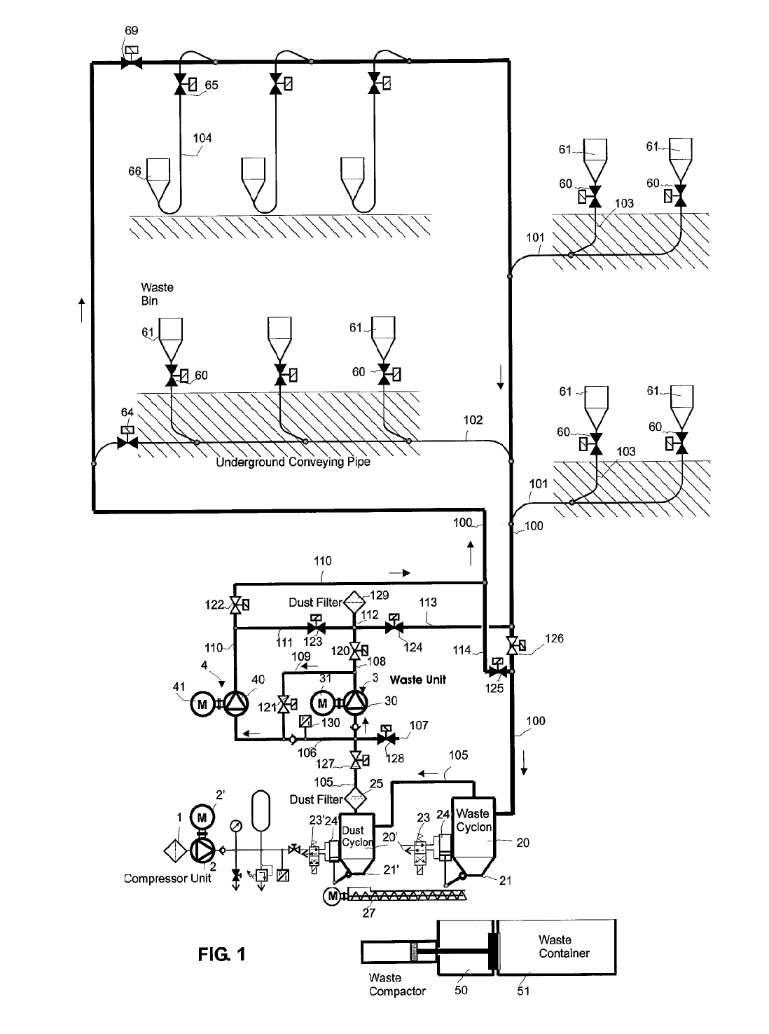

In FIG. 1, reference number 61, 66 designates a feed station of materials, particularly of waste material, intended to be conveyed, from which station material, particularly waste material, such as household waste, intended to be conveyed is fed to the conveying system. The system can comprise several feed stations 61, 66 from which the material intended to be conveyed is fed to a conveying piping 100, 101, 102, 103, 104. Typically, the conveying piping comprises a main conveying pipe 100 into which several branch conveying pipes 101, 102 can have been connected and into which again several feed stations 61, 66 can have been connected via feed pipes 103, 104. The fed material is conveyed along the conveying piping 100, 101, 102, 103, 104 to a separator device 20 in which the material being conveyed is separated, e.g. due to dropping rate and centrifugal force, from conveying air. The separated material is removed, e.g. when required, from the separator device 20 to a material container, such as a waste container 51, or to further treatment. The material container can comprise, as in the embodiment of the figures, a waste compactor 50 from which the material is further conveyed to the waste container 51. In the embodiment of FIG. 1, the separator device 20 is provided with material outlet elements 21, 24. From the separating device 20, a pipe 105 leads to means 3 for generating underpressure in the conveying pipe. In the embodiment of FIG. 1, the means for generating underpressure comprise a vacuum pump unit 3. With the means for generating underpressure, underpressure required for conveying the material is provided in the conveying piping 100, 101, 102, 103, 104. The vacuum pump unit 3 comprises a pump 30 which is operated by an actuator 31.

The system can further comprise a blower unit 4 which is connected in the embodiment of the figure from the blowing side to the conveying pipe 100. The conveying pipe 100 is a section of a circuit which in the embodiment of the figure consists of the main conveying pipe 100, the separator element 20 and pipes 105 and 106. The blower unit 4 comprises a blower 40 and its actuator 41. The blower 40 of the blower unit 4 is arranged from the suction side to the pipe 105, 106 coming from the separating device 20. The conveying pipe 100 is thus connected to the blower 40 on its blowing side. In the main conveying pipe is arranged at least one valve element 69 typically between the blower 40 of the blower unit 4 and the feed pipes 103 and/or branch conveying pipes 101, 102 in the blowing direction of the blower 40. The blower also generates underpressure together with the vacuum generator.

The valve element 64 and 69 being in the closed position, the blower 40 raises pressure to a section between the blower and the valve element 69 in the conveying pipe 100. Equivalently in a section of the circuit on the suction side of the vacuum generator 3 and/or the blower 40, when travelling against the conveying direction and/or the air flow direction, which comprises in the embodiment of the figure the pipes 105, 106, at least one separator device 20, 20′ and a section of the main conveying pipe 100 from the separating device as far as the valves 69, underpressure prevails when the valves 69, 64 and the valves 60, 65 of the feed stations 61, 66 to the conveying pipe are closed.

In the embodiment of FIG. 1, the branch conveying pipe 102 extends from the pressure side of the main conveying pipe 100 to the suction side of the main conveying pipe i.e. forms a section of a smaller circuit. In the branch conveying pipe 102, at its end on the side of the pressure side of the main conveying pipe, is arranged the valve 64. The valve 64 of the branch conveying pipe being open and the valve 69 of the main conveying pipe being closed, a smaller circuit is formed in the embodiment of the figure in which air circulates from the blower 40 from the pressure side of the main conveying pipe via the branch conveying pipe 102 to the suction side of the main conveying pipe and further via the separator device to the pipe 105 and 106. When the vacuum pump unit runs, part of air circulating in the circuit is led to an outlet 34.

In the embodiment according to FIG. 1, into the main conveying pipe 100 are connected two first branch conveying pipes 101. In the figure, into both first branch conveying pipes 101 are connected two feed stations 61. Into the second branch conveying pipe 102 are connected three feed stations 61 by means of feed pipes 103. However, there can be more of them, e.g. 20. They can be opened and the material conveyed to the conveying pipe stepwise, first the one closest in relation to the separator element 20, then the next closest etc.

In the upper part of the figure, there are further three feed stations 66 connected directly to the main conveying pipe via feed pipes 104.

The sum of suctions provided by the vacuum unit 3 and the blower unit 4 to the conveying pipe 100, in the figure from the side of the separator element, is advantageously greater than the blowing provided by the blower unit, whereby conveyance takes place in underpressure. With the blower 40, it is typically possible to provide pressure which is e.g. in the range of 0.1-0.5 bar. With the vacuum generators, it is again typically possible to provide underpressure which is e.g. in the range of 0.1-0.5 bar. The blowing stores energy (i.e. overpressure) in the section of the conveying pipe 100 between the blower 40 and the valve 69 (and the valve 64) along with the rise of pressure, when the valves 69, 64 are closed, e.g. +0.5 bar. The suction of the vacuum unit 3 stores on the other side i.e. to the section of the valve 69 and the separator element 20 (and the pipe 105) underpressure which is e.g. −0.5 bar. When at least one of the valves 69, 64 opens, the pressure difference can then be even 1 bar. The suction being greater than blowing, underpressure is provided in the piping, whereby waste can be sucked inside the piping from a funnel of the feed station 61.

The suction being greater than the blowing, which is the target in the system according to the invention, material fed to the conveying pipe, particularly waste material, will not be compressed and compacted, but will be able to travel “freely” in the pipe conveyed by conveying air. Then, the potential of the material being conveyed to form blockages is considerably lower than in a situation in which the blowing is greater than the suction, whereby there is a risk that the material being conveyed will accumulate and block the conveying pipe. Furthermore, underpressure decreases the power required to convey the material, because even partial underpressure in relation to the material portion being conveyed on the side of the conveying direction considerably decreases air drag, among others. In the figure, arrows designate the direction of motion of air in the piping in the operating mode.

In conveying material, such as conveying waste material, when the material of the feed point is first conveyed by suction via the feed pipe 101, 103 or 104 to the conveying pipe, extremely fast acceleration and conveyance are provided for the material.

The conveying power provided by the pressure difference can then be e.g. in a pipe of a diameter of 400 mm about in the range of 12.32 kN (1,256 kp). The pressure side of the conveying pipe 100, i.e. in the example of the figure the section between the blower 40 and the valve 69, 64, can be substantially smaller of its diameter than the suction side of the conveying pipe, i.e. typically at least the section between the valve 69, 64 and the separator element 20. The pressure side can then be formed more advantageous of its diameter and costs.

In the embodiment of the figure, in the pipe 106 on the suction side of the blower is formed a fitting 107 in which there is a valve 128 by opening of which extra air can be brought on the suction side of the vacuum unit and/or the blower from outside the circuit. By opening the valve 128, it is possible to raise the pressure of air in the conveying pipe if required and an increased conveying rate is provided for conveying the material.

To the feed pipes 103, 104 is arranged the outlet valve 60, 65 which is opened and closed so that material portions of suitable size are conveyed from the feed point 61, 66 to the branch conveying pipe 101, 102 or directly to the main conveying pipe 100. Material is fed from the feed point 61, 66, such as a waste container, when after the container is full, the outlet valve 60, 65 is opened either automatically or manually.

The system typically operates as follows: An outlet hatch 21 of the separator device 20 is closed and a valve 26 between the main conveying pipe 100 and the separator device 20 is open. The vacuum pump unit 3 and/or the blower unit 4 maintains underpressure in the main conveying pipe 100. A suction effect provided by the vacuum unit 3 and the blower unit 4 together via the separator device 20 to the conveying pipe 100 is greater than a pressure effect provided by the blower unit 4 to the conveying pipe 100 at its one end i.e. to the blowing side, to the section between the blower 40 and the valve 69 or the valve 64.

All outlet valves 60, 65 in the vicinity of the feed points i.e. waste containers are closed. In the start situation, the area valve 64 of the branch conveying pipe 102 and the line valve 69 of the main conveying pipe 100 are closed.

Let us assume that a waste container of the feed point 61 belonging to the area of the first branch conveying pipe 101 is to be emptied. Based on an emptying signal, the outlet valve 60 is momentarily opened, e.g. for 2-10 seconds, whereby the material being conveyed, such as waste material, conveys from the effect of underpressure to the branch conveying pipe and further to the main conveying pipe 100. The outlet valve 60 is typically closed after a few seconds after the start situation. The vacuum pump unit 3 maintains desired underpressure and the blower unit 4 starts unless not already running. The valve 69 is opened, whereby in the piping is provided blowing i.e. an intensified pressure effect and suction effect which conveys the material portion being conveyed along the piping to the separator device 20.

When the separator device 20 is full, the valve 26 of the conveying pipe 100 closes and a control valve 23 opens, whereby the actuator 24 of the outlet hatch 21 of the separator device opens the outlet hatch 21 and the material accumulated in the separator device is emptied in the compactor device 50 and further in the waste container 51. The outlet hatch 21 of the separator device 20 is closed and the valve 26 opened.

After this, the start situation is reverted and the emptying process can be repeated or the emptying of some other feed point/feed points can be implemented.

The waste container 51, such as a waste freight container, is replaced or emptied when it is full.

In waste conveyance, it is possible to optimise air circulation and blowing so that the blowing is always directed as close as possible to the material portion being conveyed. If a material portion fed directly via the feed point 66 is being conveyed, first is opened the valve 69 in the main conveying pipe 100. After the material portion has passed the connecting point of the branch conveying pipe 102 and the main conveying pipe 100 in the case of the figure, the valve 64 of the branch conveying pipe is opened and the valve 69 of the main conveying pipe is closed, whereby the blowing effect directs at the material portion being conveyed as close as possible and the motion of the material portion can be best maintained in the conveying pipe.

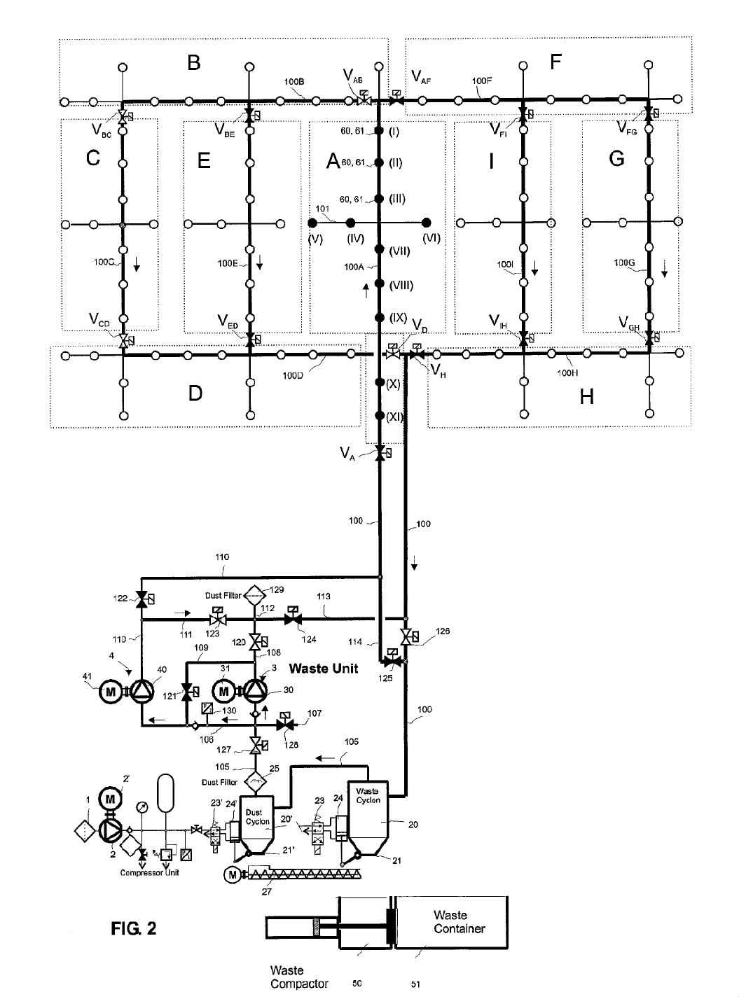

FIG. 2 shows an advantageous embodiment of the system. In the figure, the feed stations or feed points 61 and gate elements 60 in connection with them are diagrammatically designated along the conveying piping 100 with one circle. The feed point 61 typically comprises a feed container, such as a funnel, and the valve element 60 by which a connection from the feed point to the conveying pipe 100 is closed and opened. The system conveying piping 100 and the feed points 61 along with it are dividable by area valves V_{A}, V_{AB}, V_{BC}, V_{BE}, V_{BE}, . . . etc. arranged in the conveying piping to operating areas A, B, C, D, E, F, G, H, I. In the figure, each part of the conveying piping 100 of the operating area is designated with the letter of the corresponding operating area, whereby at the point of the operating area A the conveying pipe is designated with 100A and at the point of operating area B the conveying pipe is designated with 100B. A corresponding designation is used for the other operating areas. The operation of the system is controlled so that, for emptying the feed points of a desired operating area, at least one valve is open in the material conveying direction in relation to the operating area of the conveying pipe 100 and on the supply side of the conveying air i.e. on the side of suction, whereby the suction is able to affect the conveying pipe of the operating area. Let us assume that, in the arrangement according to the figure, the feed points 61 of the area A are to be emptied. Then, all area valves between the separator element 20 and the operating area A in the conveying pipe 100 (the sections 100B, 100C, 100D of the conveying pipe in the figure) in the conveying direction are open (the valves V_{AB}, V_{BC}, V_{CD}, V_{D} in the figure). Then, suction provided by at least one vacuum generator 3 prevails in the conveying piping 100A in the operating area A. At least one valve V_{A} on the blowing side of the conveying pipe 100A is closed, whereby only suction prevails in the operating area A. The feed points 61 of the operating area or at least part of them are emptied so that the connection of the feed point 61 (I) closest to the delivery end in the conveying direction of the conveying pipe, i.e. in the embodiment according to the figure closest to the separator device 20, to the conveying pipe 100A is opened first, whereby the material is able to convey from the first feed point to the conveying pipe, and before the connection of the first feed point (I) to the conveying pipe closes, the connection of the next feed point 61 (II) to the conveying pipe is opened. In the embodiment of the figure, this is, when travelling against the material conveying direction, the next feed point 61 (II) intended to be emptied. After this, the connection of the first feed point 61 (I) is closed to the conveying pipe.

Equivalently, the connection of the third feed point 61 (III) intended to be emptied to the conveying pipe is opened before the connection of the second feed point 61 (II) to the conveying pipe is closed. This operation is repeated until all desired feed points have been emptied. In the figure, it has been considered emptying all the feed points 61 of the area A, whereby their emptying sequence to the conveying pipe 100, 100A is designated in the figure by numerals within parentheses: (I), (II), (III), (IV), (V), (VI), (VII), (VIII), (IX), (X), and (XI). When the passage of the last feed point 61 (XI) intended to be emptied in the operating area A to the conveying pipe 100 has been opened, the material has conveyed to the conveying pipe 100, 100A and the passage of the feed point to the conveying pipe is closed, a connection is opened in the conveying pipe 100A of the operating area A from the blowing side i.e. the blower 4 by opening at least one valve element V_{A} which is between the operating area A and the blower device 4 blowing to the conveying pipe 100. Then, an intensified conveying effect (suction and blowing together) is provided for the material being conveyed transferred in the conveying pipe 100, 100A, 100B, 100C, 100D. The conveying air circulates on a route designated with arrows in the figure, whereby material portions conveyed from the feed points to the conveying pipe convey in the conveying piping on the route, in the example of the figure, which passes the areas B, C and D, and further to the separator device 20 in which the material being conveyed is separated from conveying air. In the figure, the area valves V_{BE} and V_{ED} of the conveying pipe 100E of the operating area E are closed, whereby conveying air and material being conveyed are not able to access the conveying pipe 100E of the operating area E but circulate via the conveying pipe 100C of the area C. In connection with the emptying of different operating areas, the material conveying route from the operating area to a delivery station, such as to the separator element 20, can be optimised by keeping the area valves open along the desired conveying route.

Material is conveyed in the conveying pipe to the separator device 20. The separator device 20 is emptied when required, e.g. to the material container 51, in connection with which there can be the compactor device 50. In the system according to the figure, a second separator device 20′ is further arranged in the conveying air channel 105 after the separator element for separating smaller particles from conveying air. The particles separated by the second separator element 20′ can be conveyed e.g. by a conveyor 27 to the material container 51. The second separator element 20′ is followed in the conveying air channel 105 in the air circulation direction by a filter element 25 for removing small particles from conveying air. The air channel 105 is connected on the suction side of the vacuum generator 3 and the conveying air channel 105 branches before the vacuum generator 3 to a second conveying air channel 106 which is connected on the suction side of the blower device 4. The blowing side of the blower device is connected directly or via an air channel 110 to the conveying pipe 100. The conveying piping 100 comprises at least one circuit in which conveying air can be circulated from the blowing side of the blower via the separator element 20 on the suction side. It is possible to regulate with the valves which one or ones of the operating areas A, B, C, D, E, F, G, H, I are connected to the active conveying circuit of the conveying pipe 100.

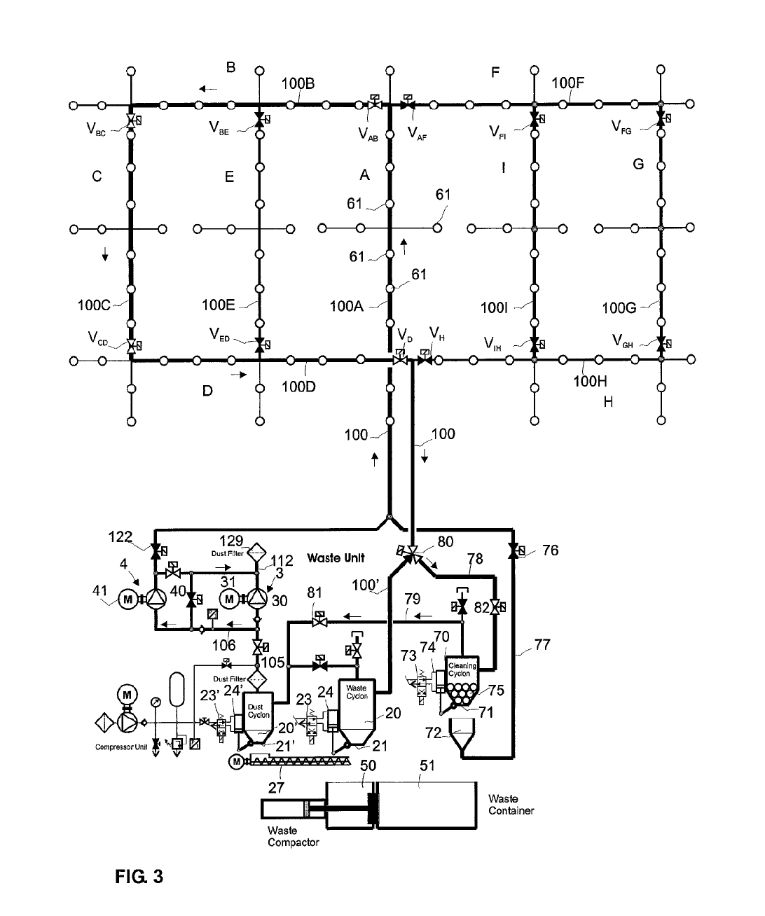

FIG. 3 shows a cleaning system according to the invention connected to a system corresponding the system of FIG. 2, which comprises a cleaning separator 70 which is connectable to a circuit a section of which is formed by at least a part of the conveying piping 100. In the embodiment of the figure, the cleaning separator 70 is connectable to the conveying pipe 100 in which is arranged a valve element 80, such as a three-way valve, by means of which the conveying air circulation is controlled either via the separator device 20 of material conveyance or via the cleaning separator 70. The cleaning separator 70 is connectable via an air channel 79 to the air channel 105 leading to the suction side of at least one pump device, such as the vacuum generator 3 and/or the blower 4. In the figure, in the cleaning separator 70 are arranged cleaning means 75, such as cleaning balls or line pigs, which can be removed from the cleaning separator by opening an outlet hatch 71 with actuators 72, 74. The cleaning device further comprises a feed point 72 of cleaning agent and/or cleaning means which is in the embodiment of the figure a funnel in which the cleaning agent and/or at least one cleaning means is settable.

The feed point 72 of cleaning agent and/or cleaning means is advantageously arranged into connection with the cleaning separator 70 so that the cleaning agent and/or the cleaning means 75 are conveyable from the cleaning separator to the feed point by opening the outlet hatch of the cleaning separator. In the embodiment of the figure, the feed point 72 is arranged below the outlet hatch of the cleaning separator whereby, by opening the outlet hatch, the cleaning agent and/or cleaning means convey to the feed point of cleaning agent and/or cleaning means gravitationally. From the feed point 72 of cleaning agent and/or cleaning means, from its lower part, leads a cleaning channel 77 which is connectable in the conveying pipe 100 on its supply side. In the cleaning channel 77 is arranged a valve element 76 by means of which the connection of the cleaning channel 77 to the conveying pipe 100 can be opened or closed. When the valve 76 of the cleaning channel 77 is opened, underpressure prevailing in the piping is able to convey the cleaning agent and/or at least one cleaning means 75 from the feed funnel of the feed point 72 via the cleaning channel 77 to the conveying pipe 100.

Conveying air is controlled to circulate in a circuit a section of which is formed by at least a part of the conveying pipe 100 intended to be cleaned. The cleaning agent and/or cleaning means 75 circulate in the conveying pipe due to suction/blowing in the circuit provided by at least one pump device, such as the vacuum generator and/or the blower 4, and return to the cleaning separator 70 in which the cleaning agent and/or cleaning means 75 are separated from conveying air flow, advantageously due to centrifugal force, and convey in the lower part of the cleaning separator 70. If required, the cleaning agent and/or cleaning means 75 can be replaced or cleaned and the cleaning circulation in the circuit can be repeated or next some other part of the piping can be cleaned by connecting it to the circuit. The cleaning means can also comprise e.g. grain-like material, whereby a cleaning charge typically consisting of cleaning agent, liquid and grain-like material is conveyed from the feed point 72 by means of a pressure difference in the circuit comprising the section of the conveying pipe intended to be cleaned. With the cleaning agent and/or cleaning means, the walls of the pipe being cleaned are advantageously treated mechanically and/or chemically.

The starting point of the figure is that the pipe sections 100A, 1008, 100C and 100D of the conveying pipe 100 are to be cleaned. The conveying pipe is dirty because it has been used in conveying e.g. waste material from one or more feed points 61 to the separator device 20 and further to the material container, such as the waste container 51. The cleaning of the pipe is performed so that the cleaning means 75 are at first in the cleaning separator 70, with the pump device, such as the vacuum generator 3 and/or the blower 4, underpressure is provided in the conveying pipe in the section to be cleaned. The suction side of the pump device is connected to the conveying air channel 79 which is in connection with the cleaning separator. The cleaning separator 70 is again connected on the inlet end of the conveying pipe 100 with the valve element 80. The valve element is a three-way valve by means of which the conveying pipe can be connected either in the normal conveying mode to the separator device 20 or in the cleaning mode to the cleaning separator 70. The valve element 76 in the channel 77 connecting the cleaning feed point 72 to the conveying pipe is closed. The valve element 122 in the channel connecting the blowing side of the pump device, such as the vacuum generator 3 and/or the blower 4, to the conveying pipe 100 is closed. Let us assume that the piping is to be cleaned with cleaning means 75 which are ball-shaped in the figure. The cleaning means 75 are e.g. arranged according to the inner diameter of the pipe. They can also be of some other shape and their size can have been arranged according to the target of application. The cleaning means 75 can also be of elastic material, e.g. like a sponge, whereby its diameter can be a little larger than the pipe being cleaned in order for it to be pressed suitably within the pipe and to effectively clean the inner surface of the pipe. After this, the valves 81 and 82 are closed and the outlet hatch 71 of the cleaning separator is opened, whereby the cleaning means convey to the feed funnel 72. The outlet hatch 71 of the cleaning separator is closed. The valve 76 of the cleaning line and the valves 81 and 82 are opened, whereby underpressure is able to affect via the cleaning separator 70 the conveying pipe and further the cleaning channel 77 and at least one cleaning means 75 in the feed funnel, whereby it conveys from the effect of a pressure difference along the cleaning channel 77 to the conveying pipe 100. In the conveying pipe is formed by opening and closing valves a section of the conveying pipe i.e. a route intended to be cleaned, in the figure from the feed funnel 75 via the cleaning channel 77 to the sections 100A, 100B, 100C, 100D of the conveying pipe and further back to the cleaning separator 70.

When the cleaning means have moved in the circuit past the connecting point of the conveying pipe of the cleaning channel and/or the conveying air channel 110 coming from the pressure side of the pump device, the conveyance of the cleaning means in the circuit can be intensified by opening the valve 122, whereby there is a connection from the pressure side of the pump device, such as the blower 4 and/or the vacuum unit 3, to the conveying pipe. Then, underpressure affects the conveying pipe from the side of the cleaning separator and pressure from the pressure side of the pump device, whereby the pressure difference of conveyance is greater and a more effective conveyance of the cleaning means and/or cleaning agent is provided. At the same time, the volume of outlet air of the pump device decreases substantially, whereby possible fine-particle and odour nuisances are minimised.

The system conveying piping 100 is dividable by area valves V_{A}, V_{AB}, V_{BC}, V_{BE}, V_{BE}, . . . etc. arranged in the conveying piping to operating areas A, B, C, D, E, F, G, H, I. In the figure, each part of the conveying piping 100 of the operating area is designated with the letter of the corresponding operating area, whereby at the point of the operating area A the conveying pipe is designated with 100A and at the point of operating area B the conveying pipe is designated with 100B. A corresponding designation is used for the other operating areas. The operation of the system is controlled so that, for cleaning a section of conveying pipe 100 of the desired operating area, the operating area has to belong to the cleaning circuit in which the conveying air is able to circulate and in which the cleaning means can be fed.

In the embodiment according to the figure, the cleaning apparatus is arranged into connection with an actuating unit of the material conveying system, such as in connection with a waste conveying system in a waste station or equivalent. An advantage here is that the cleaning operation can be performed and controlled in one place.

The cleaning process can be performed when required. Typically, cleaning is performed e.g. in situations in which material of different sort is fed from the material feed points. In a waste conveying system, it is possible to consider that e.g. organic waste, mixed waste and waste paper are conveyed in the material conveying pipe. Then, cleaning can be performed between the conveyance of different waste sorts.

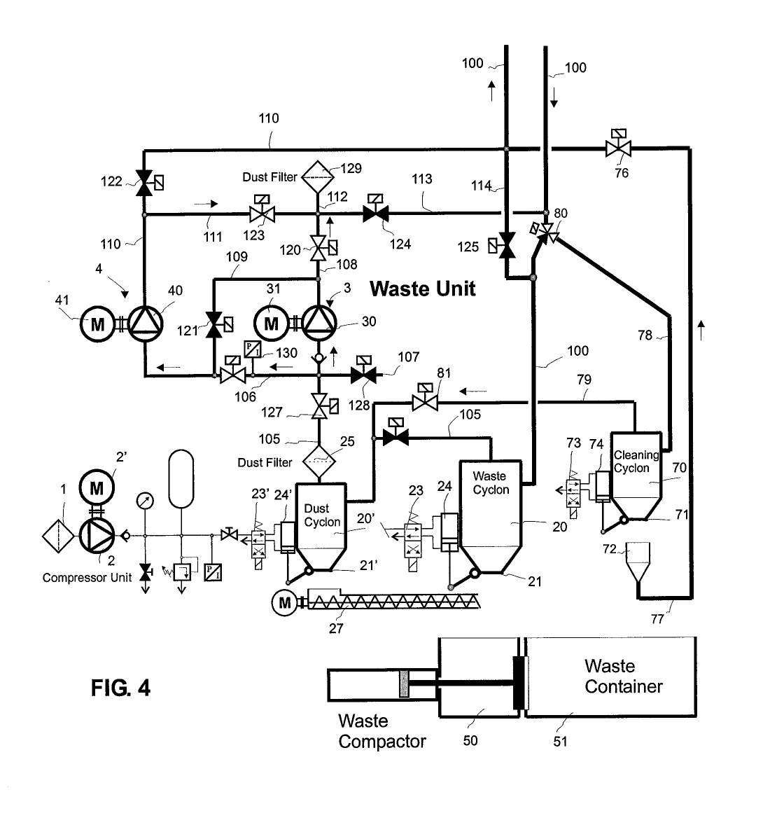

FIG. 4 schematically shows a part of a pneumatic material conveying system, particularly a waste material conveying system. The figure shows an actuating unit of the system and a delivery end of material of the conveying system i.e. a part of the system in which the material being conveyed is separated from conveying air.

In the system according to the figure, the main conveying pipe 100 is connected in the normal conveying mode from the supply side to the separator device 20. The system comprises at least one vacuum generator 3 the suction side of which is connectable to the separator device 20 or to the conveying air channel 105 coming from the separator device so that, with the vacuum generator 3, it is possible to provide underpressure at least to a section of the conveying pipe 100. The system comprises at least one blower unit 4. An embodiment of the actuating unit according to the invention, which comprises at least one vacuum unit 3 and at least one blower unit 4, has several operating modes. The embodiment of FIG. 4 shows an operating mode in which the suction sides of both the vacuum unit 3 and the blower unit 4 are connected to the separator element or to the conveying air channel 105, 106 coming from the separator device 20, 20′. Then, suction as high as possible is providable in the conveying pipe 100. The suction side of the pump device 30 of the vacuum unit 3 and the suction side of the blower 40 of the blower unit 4 are connected in parallel in the operating mode in question, whereby a suction effect as high as possible is provided in the conveying pipe 100. In the embodiment of the figure, the blowing side of the vacuum unit 3 and the blowing side of the blower unit 4 are arranged in the operating mode in question to blow to the outlet channel 112, in which at least one filter device 129 for filtering outlet air is typically arranged, such as in the embodiment of the figure. This operating mode can be particularly utilised in a situation in which material being conveyed, such as waste material, or as in the invention cleaning means 75 and/or cleaning agent and/or liquid, is conveyed from one or more feed points 61, 72 or equivalents to the conveying pipe 100. Then, an extremely effective feed of material is provided in the conveying pipe.

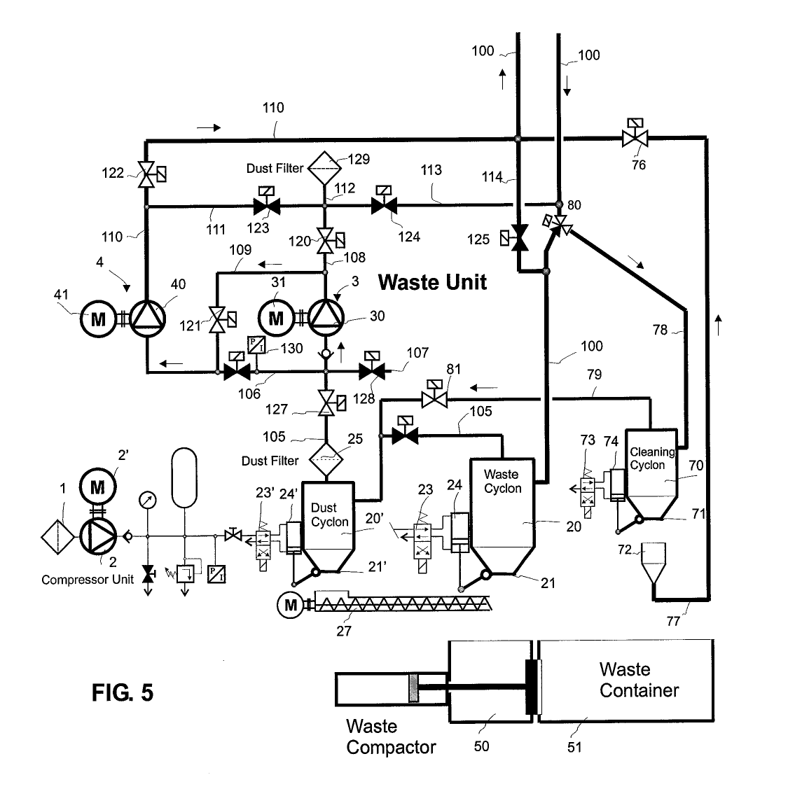

FIG. 5 shows a second operating mode of the actuating unit of the system according to the invention in which the blowing side of the vacuum generator 3 is connected to the suction side of the blowing unit 4 so that at least part of air on the blowing side of the vacuum generator is circulated on the suction side of the blowing unit. In the embodiment of the figure, a conveying air channel 109 is arranged from the conveying air channel 108 of the blowing side of the vacuum unit 3 and conveyed to a medium channel 106 leading to the suction side of the blower unit. In the conveying air channel 109 is arranged a valve element 121 which is open in the operating mode of FIG. 3. The blower unit 4 is in the operating mode of FIG. 3 arranged to blow in the air channel 110 which leads to the conveying pipe 100 on its supply side. Then, in the conveying pipe at least on its return side is provided underpressure and a suction effect and in the conveying pipe on the supply side equivalently a blowing effect. In this operating mode, it is thus possible to provide in the circuit, a section of which is formed by the conveying pipe 100, a maximal conveying air flow, because the vacuum unit 3 sucks from the delivery end of the conveying pipe and the blower unit blows from the supply end of the conveying pipe. In the operating mode, the volume of outlet air can be kept minimal or nonexistent, because the conveying air is circulated in the circuit, a section of which is formed by a part of the conveying pipe 100, and the blowing air of the vacuum unit is conveyed on the suction side of the blowing unit and further to the conveying pipe 100 and in the circulation back via the separator device 20, 70 on the suction side of the vacuum unit. The vacuum unit and the blower unit are connected “in series”. In this operating mode, an extremely efficient conveying effect is provided for materials being conveyed in the conveying pipe. This operating mode is utilised when conveying material in the conveying pipe to the delivery end, particularly to the separator device. Combining blowing with suction is extremely efficient, because the blowing effect i.e. the production of pressure is clearly more cost-effective than the production of underpressure.

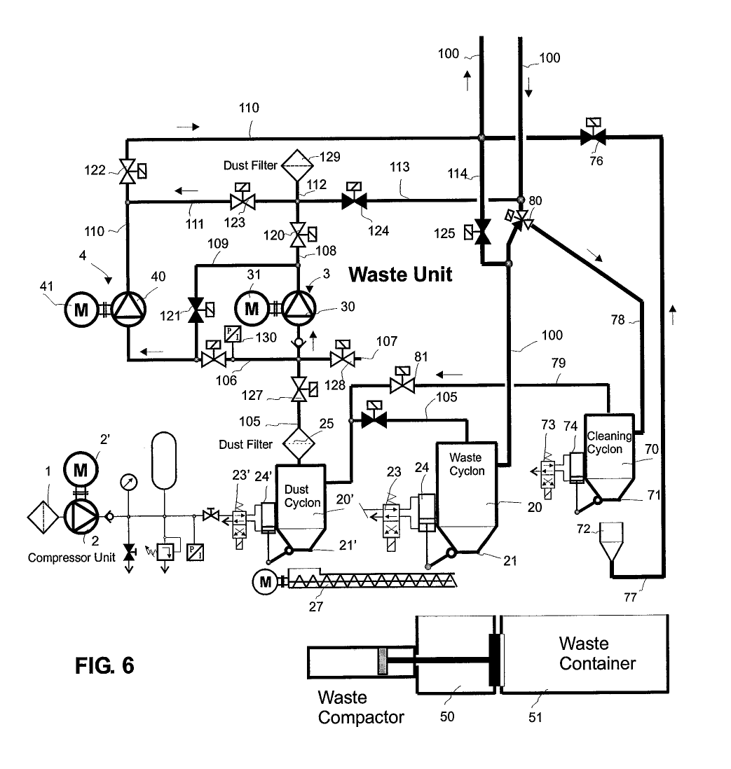

FIG. 6 shows a third operating mode of the actuating unit of the system, in which the blowing side of the vacuum unit 3 is connected to the air channel 110 connected on the supply side of the conveying pipe 100 and the blowing side of the blower unit 4 is connected to the air channel 110 connected on the supply side of the conveying pipe 100. The suction side of the vacuum generator is connected to the separator device 20, 70 or the air channel 105 coming from it. The suction side of the blower unit 4 is connected to the separator device 20, 70 or to the conveying air channel 105 coming from it with the air channel 106. Due to a possible requirement for extra air, there is arranged an inlet air channel 107 the valve of which is open in the embodiment of the figure, whereby on the suction side of the vacuum generator 3 and/or the blower 4 is led extra air. In the operating mode of this embodiment, a maximal air flow is provided in the piping, because both the vacuum generator and the blower unit are arranged to blow in the conveying piping and suck from the conveying piping. This operating mode can be utilised for the air flushing of the conveying piping 100 and/or for the drying of the conveying piping. In the vacuum unit 3 and/or the blower unit 4, the air is compressed and heats up. This facilitates and speeds up the drying operation.

In a case according to the invention, the conveying pipe 100 is at least a section of a suction/blowing circuit, the output end and inlet end of which are advantageously arranged into connection with the waste station and in which the output end of the suction/blowing circuit is on the blowing side of the vacuum generator and/or blower 40 and the inlet end on the suction side of the vacuum generator and/or blower 40. The vacuum generator and/or blower can circulate air in the suction/blowing circuit a section of which is formed by the conveying pipe 100. The feed points 61, 66 can be located decentralised along the system pipings distributedly. In connection with the waste conveying system, the feed points can be e.g. waste bins or waste chutes.

The invention thus relates to a method for cleaning a conveying pipe of a pneumatic material conveying system, such as a waste conveying system, in which method, in the conveying pipe being cleaned is fed at least one cleaning means 75 and/or cleaning agent and/or liquid, and in the pipe is provided a pressure difference, and the cleaning means and/or cleaning agent and/or liquid is brought to move from the effect of the pressure difference through a conveying pipe section intended to be cleaned for cleaning the pipe. In the method, at least a part of the conveying pipe 100 intended to be cleaned is connected as a section of a circuit in which conveying air is circulated at least during the conveyance of cleaning means 75 and/or cleaning agent and/or liquid with at least one first pump device, such as a vacuum unit 3, and/or with at least one second pump device, such as a blower unit 4.

According to an advantageous embodiment of the invention, the method is used for cleaning the conveying pipe 100 of a waste conveying system.

According to an embodiment of the invention, in the method, the cleaning means 75 are fed from a feed point 72 and they return after the cleaning circulation to a separator device 20, 70 which is advantageously substantially in the same space with the feed point 72.

According to an advantageous embodiment, in the method is used as the cleaning means 75 a cleaning ball or some other cleaning means suitable for the pipe, such as a so-called “line pig” of a pipe. In the method, the cleaning means 75 can be used either on its own or together with liquid and/or cleaning agent.

According to an advantageous embodiment, in the method, the cleaning means and/or cleaning agent and/or liquid is fed to the piping from the feed point 72 of cleaning means which is connected to the conveying piping with a cleaning line 77 from the effect of a pressure difference.

Typically, the cleaning means and/or cleaning agent and/or liquid is circulated via a section of the conveying pipe 100 intended to be cleaned to the separator device 20, 70, particularly a cleaning separator 70, in which the cleaning means 75 and/or cleaning agent and/or liquid is separated from conveying air.

According to an advantageous embodiment, the cleaning means and/or cleaning agent and/or liquid is controlled after the cleaning circulation, advantageously with a multi-way valve, such as a three-way valve 80, to the separate cleaning separator 70.

According to an advantageous embodiment, in the method, in the first operating mode, underpressure is provided in the circuit with at least one first pump device, such as a vacuum generator 3, and/or one second pump device, such as the blower unit 4, the suction side of which is connected to the separator element 20, 70 or to the conveying pipe 100 via an air channel 105, 106, 79 leading to it. Then, underpressure is provided in the conveying pipe, by means of which a pressure difference is formed for conveying the cleaning means and/or cleaning agent and/or liquid in the conveying pipe.

According to an advantageous embodiment, in the first operating mode of the method, the blowing side of at least one first pump device, such as the vacuum unit 3, and/or one second pump device, such as the blower unit 4, is connected to an outlet channel 112 or equivalent. Then, underpressure and suction as effective as possible are provided in the conveying pipe.

According to an advantageous embodiment, in the second operating mode of the method, the blowing side of at least one first pump device, such as the vacuum unit 3, is connected to the suction side of at least one second pump device, such as the blower unit 4, so that at least part of air of the blowing side of the first pump device is circulated on the suction side of the second pump device. Then, an intensified pressure difference is provided in the conveying pipe, in which on the side of the separator device 20, 70 there is underpressure, and on the reverse side in relation to the separator element of at least one cleaning means 75 being conveyed higher pressure provided by blowing.

According to an embodiment of the invention, in the method, pressure is provided in the circuit with at least one pump device, such as the vacuum generator 3 and/or the blower 4, the blowing side of which is connected to blow in the circuit.

According to another embodiment of the invention, in the method, after the cleaning stage at least a part of the conveying piping is flushed and/or dried with air by circulating conveying air in the circuit, particularly by blowing in the circuit with at least one first pump device, such as the vacuum generator 3, and/or one second pump device, such as the blower 4.

According to an advantageous embodiment, the method is used before changing the sort of the material being conveyed. Typically, it is possible e.g. in waste conveyance to utilise one conveying pipe to convey different sorts of waste, such as organic waste, mixed waste and/or waste paper, whereby the conveying piping can be cleaned before changing the material being conveyed. According to an advantageous embodiment, the method is used in connection with a waste conveying system when the material being conveyed in the conveying pipe is changed, e.g. due to sorting of wastes.

The invention also relates to an apparatus for cleaning a conveying pipe 100 of a pneumatic material conveying system, such as a waste conveying system, which apparatus comprises means for feeding a cleaning means and/or cleaning agent and/or liquid in the conveying pipe intended to be cleaned and means 3, 4 for providing a pressure difference in the conveying pipe 100 at least during cleaning. At least a part of the conveying pipe 100 is connectable as a section of a circuit in which conveying air is circulated at least during the conveyance of the cleaning means 75 and/or cleaning agent and/or liquid with at least one first pump device, such as a vacuum unit 3, and with at least one second pump device, such as a blower unit 4.

According to an advantageous embodiment, the apparatus comprises a feed point 72 of cleaning means which is connected to the conveying piping with a cleaning line 77 and in which there is a valve element 76 for opening and closing a connection from the feed point to the conveying pipe.

In an advantageous embodiment, the means for generating a pressure difference comprise at least one first pump device, such as a vacuum generator 3, and/or one second pump device, such as the blower unit 4, the suction side of which is connectable to the separator element 20, particularly a cleaning separator 70, or to the conveying pipe 100 via an air channel 105, 106, 79 leading to it.

According to an advantageous embodiment, the apparatus comprises means 80 for changing the travel of the conveying air circulation between two or more separator devices 20, 70. In the embodiment of the figure, a multi-way valve, such as a three-way valve 80, is used which is arranged at a crossing point of the conveying pipe 100 and channels 78, 100′ leading to at least two separator devices 20, 70.

According to an advantageous embodiment, the feed point 72 of cleaning means and the cleaning separator 70 are arranged in the vicinity of each other, advantageously substantially in the same space. In the embodiment of the figure, the feed point 72 and the return point i.e. the cleaning separator 70 of the cleaning system are arranged into connection with a waste unit, typically in the same space, such as a waste station.

According to an advantageous embodiment, in the first operating mode, the blowing side of at least one first pump device, such as the vacuum unit 3, and/or one second pump device, such as the blower unit 4, is connected to an outlet channel 112 or equivalent. This is used only for a short time in a stage in which the cleaning means are conveyed from the feed point to the conveying pipe.

In the second operating mode, the blowing side of at least one first pump device, such as the vacuum unit 3, is connected to the suction side of at least one second pump device, such as the blower unit 4, so that at least part of air of the blowing side of the first pump device is circulated on the suction side of the second pump device. In this embodiment, the power of two pump devices is utilised and a greater pressure difference and/or conveying air rate is provided.

According to another embodiment, the system is arranged to provide pressure in the circuit with at least one pump device, such as the vacuum generator 3 and/or the blower 4, the blowing side of which is connected to blow in the circuit.

Advantageously, the apparatus also comprises means for flushing at least a part of the conveying piping 100 with air and/or for drying by circulating the conveying air in the circuit, particularly by blowing in the circuit with at least one first pump device, such as the vacuum generator 3, and/or one second pump device, such as the blower 4.

According to an embodiment, as the cleaning means 75 is a cleaning ball or some other cleaning means suitable for the conveying pipe 100, such as a so-called “line pig” of a pipe.

According to an advantageous embodiment of the invention, the apparatus is connected to a waste conveying system.

It is obvious to those skilled in the art that the invention is not limited to the embodiments described above, but it may be varied within the scope of the enclosed claims. When necessary, the features possibly described in this specification together with other features may also be used separately from each other.

1. A method for cleaning a conveying pipe of a pneumatic material conveying system, such as a waste conveying system, in which method, in the conveying pipe being cleaned is fed at least one cleaning means (75) and/or cleaning agent and/or liquid, and in the pipe is provided a pressure difference, and the cleaning means and/or cleaning agent and/or liquid is brought to move from the effect of the pressure difference through a conveying pipe section intended to be cleaned for cleaning the pipe, characterised in that, in the method, at least a part of the conveying pipe (100) intended to be cleaned is connected as a section of a circuit in which conveying air is circulated at least during the conveyance of the cleaning means (75) and/or cleaning agent and/or liquid with at least one first pump device, such as a vacuum unit (3), and/or at least one second pump device, such as a blower unit (4).

2. A method according to claim 1, characterised in that the method is used for cleaning the conveying pipe (100) of a waste conveying system.

3. A method according to claim 1, characterised in that, in the method, the cleaning means (75) are fed from a feed point (72) and they return after the cleaning circulation to a separator device (20, 70) which is advantageously substantially in the same space with the feed point (72).

4. A method according to claim 1, characterised in that, in the method, as the cleaning means (75) is used a cleaning ball or some other cleaning means suitable for the pipe, such as a so-called “line pig” of a pipe.

5. A method according to claim 1, characterised in that, in the method, the cleaning means and/or cleaning agent and/or liquid is fed to the piping from the feed point (72) of cleaning means which is connected to the conveying piping with a cleaning line (77) from the effect of a pressure difference.

6. A method according to claim 1, characterised in that the cleaning means and/or cleaning agent and/or liquid is circulated via a section of the conveying pipe (100) intended to be cleaned to the separator device (20, 70) particularly a cleaning separator (70), in which the cleaning means (75) and/or cleaning agent and/or liquid is separated from conveying air.

7. A method according to claim 1, characterised in that the cleaning means and/or cleaning agent and/or liquid is controlled at the end of the cleaning circulation, advantageously with a multi-way valve, such as a three-way valve (80), to the separate cleaning separator (70).

8. A method according to claim 1, characterised in that, in the method, in a first operating mode, underpressure is provided in the circuit with at least one first pump device, such as the vacuum unit (3), and/or one second pump device, such as the blower unit (4), the suction side of which is connected to the separator element (20) or to the conveying pipe (100) via an air channel (105, 106) leading to it.

9. A method according to claim 1, characterised in that, in the first operating mode of the method, the blowing side of at least one first pump device, such as the vacuum unit (3), and/or one second pump device, such as the blower unit (4), is connected to an outlet channel (112) or equivalent.

10. A method according to claim 9, characterised in that, in a second operating mode of the method, the blowing side of at least one first pump device, such as the vacuum unit (3), is connected to the suction side of at least one second pump device, such as the blower unit (4), so that at least part of air of the blowing side of the first pump device is circulated on the suction side of the second pump device.

11. A method according to claim 1, characterised in that, in the method, pressure is provided in the circuit with at least one pump device, such as the vacuum generator (3) and/or the blower (4), the suction side of which is connected to blow in the circuit.

12. A method according to claim 1, characterised in that, in the method, after the cleaning stage at least a part of the conveying piping is flushed and/or dried with air by circulating conveying air in the circuit, particularly by blowing in the circuit with at least one first pump device, such as the vacuum generator (3), and/or one second pump device, such as the blower (4).

13. A method according to claim 1, characterised in that the method is utilised before changing the sort of the material being conveyed.

14. A method according to claim 1, characterised in that the method is used in connection with a waste conveying system when the material being conveyed in the conveying pipe is changed, e.g. due to sorting of wastes.

15. An apparatus for cleaning a conveying pipe of a pneumatic material conveying system, such as a waste conveying system, which apparatus comprises means for feeding a cleaning means and/or cleaning agent and/or liquid in the conveying pipe intended to be cleaned and means (3, 4) for providing a pressure difference in the conveying pipe (100) at least during cleaning, characterised in that at least a part of the conveying piping (100) is connectable as a section of a circuit in which conveying air is circulated at least during the conveyance of the cleaning means (75) and/or cleaning agent and/or liquid with at least one first pump device, such as a vacuum unit (3), and/or at least one second pump device, such as a blower unit (4).

16. An apparatus according to claim 15, characterised in that the apparatus comprises a feed point (72) of cleaning means which is connected to the conveying piping with a cleaning line (77) and in which there is a valve element (76) for opening and closing a connection from the feed point to the conveying pipe.

17. An apparatus according to claim 15, characterised in that the means for generating a pressure difference comprise at least one first pump device, such as the vacuum unit (3), and/or one second pump device, such as the blower unit (4), the suction side of which is connectable to the separator element (20), particularly a cleaning separator (70), or to the conveying pipe (100) via an air channel (105, 106, 79) leading to it.

18. An apparatus according to claim 15, characterised in that the apparatus comprises means (80) for changing the travel of the conveying air circulation between two or more separator devices (20, 70):

19. An apparatus according to claim 15, characterised in that the feed point (72) of cleaning means and the cleaning separator (70) are arranged in the vicinity of each other, advantageously substantially in the same space.

20. An apparatus according to claim 15, characterised in that, in a first operating mode, the blowing side of at least one first pump device, such as the vacuum unit (3), and/or one second pump device, such as the blower unit (4), is connected to an outlet channel (112) or equivalent.

21. An apparatus according to claim 15, characterised in that, in a second operating mode, the blowing side of at least one first pump device, such as the vacuum unit (3), is connected to the suction side of at least one second pump device, such as the blower unit (4), so that at least part of air of the blowing side of the first pump device is circulated on the suction side of the second pump device.

22. An apparatus according to claim 15, characterised in that the system is arranged to provide pressure in the circuit with at least one pump device, such as the vacuum generator (3) and/or the blower (4), the suction side of which is connected to blow in the circuit.

23. An apparatus according to claim 15, characterised in that the apparatus comprises means for flushing at least a part of the conveying piping (100) with air and/or drying by circulating conveying air in the circuit, particularly by blowing in the circuit with at least one first pump device, such as the vacuum generator (3), and/or one second pump device, such as the blower (4).

24. An apparatus according to claim 15, characterised in that as the cleaning means (75) is a cleaning ball or some other cleaning means suitable for the conveying pipe (100), such as a so-called “line pig” of a pipe.

25. An apparatus according to claim 15, characterised in that the apparatus is connected to a waste conveying system.
